(19) United States
(12) Patent Application Publication
(10) Pub. No.: US 2026/0302996 A1
(43) Pub. Date: Oct. 1, 2026

(54) CONTROL DEVICE, MOVING OBJECT, CONTROL METHOD, AND STORAGE MEDIUM

(71) Applicant: HONDA MOTOR CO., LTD., Tokyo (JP)

(72) Inventor: Ayano Yoshida, Wako-shi (JP)

(21) Appl. No.: 19/633,007

(22) Filed: Mar. 30, 2026

(30) Foreign Application Priority Data
Mar. 31, 2025 (JP) 2025-057635

(51) Int. Cl. H02P 27/08; B60L 15/00; B64C 29/00; B64D 31/16

(52) U.S. Cl. CPC H02P 27/08; B60L 15/007; B64D 31/16; B60L 2200/10; B60L 2210/30; B64C 29/00; B64D 2221/00

(57) ABSTRACT

A control device includes a control unit, a rotational speed comparison unit, a voltage comparison unit, and a voltage utilization ratio comparison unit. The control unit performs power running control in a case where: the rotational speed comparison unit determines that the rotational speed of a power generator is less than a rotational speed threshold; the voltage comparison unit determines that a capacitor voltage is equal to or greater than a voltage threshold; and the voltage utilization ratio comparison unit determines that the voltage utilization ratio is equal to or less than a voltage utilization ratio threshold.

### CROSS-REFERENCE TO RELATED APPLICATIONS

This application is based upon and claims the benefit of priority from Japanese Patent Application No. 2025-057635 filed on Mar. 31, 2025, the contents of which are incorporated herein by reference.

### BACKGROUND OF THE INVENTION

### Field of the Invention

The present disclosure relates to a control device, a moving object, a control method, and a storage medium.

### Description of the Related Art

JP 2006-352971 A discloses a device for discharging electric charge stored in a capacitor in an inverter.

### SUMMARY OF THE INVENTION

There is a need to appropriately discharge smoothing capacitors.

The present disclosure has the object of satisfying the aforementioned need.

A first aspect of the present disclosure is a control device provided in a power supply system including a power conversion device that converts alternating-current power output from a power generator into direct-current power, the control device including: a control unit configured to perform power running control to control the power conversion device in a manner so that electric power is supplied from a smoothing capacitor provided in the power conversion device to the power generator, to thereby reduce a capacitor voltage that is a voltage across the smoothing capacitor; a rotational speed comparison unit configured to compare a rotational speed of the power generator with a rotational speed threshold that has been predetermined; a voltage comparison unit configured to compare the capacitor voltage with a voltage threshold that has been predetermined; and a voltage utilization ratio comparison unit configured to compare a voltage utilization ratio, which is defined as a ratio of a voltage applied to the power generator to the capacitor voltage, with a voltage utilization ratio threshold that has been predetermined, wherein the control unit performs power running control in a case where: the rotational speed comparison unit determines that the rotational speed of the power generator is less than the rotational speed threshold; the voltage comparison unit determines that the capacitor voltage is equal to or greater than the voltage threshold; and the voltage utilization ratio comparison unit determines that the voltage utilization ratio is equal to or less than the voltage utilization ratio threshold.

A second aspect of the present disclosure is a moving object including a power supply system including the control device according to the first aspect.

A third aspect of the present disclosure is a control method for a power supply system including a power conversion device that converts alternating-current power output from a power generator into direct-current power, the control method including: a control step of causing one or more processors to perform power running control to control the power conversion device in a manner so that electric power is supplied from a smoothing capacitor included in the power conversion device to the power generator, to thereby reduce a capacitor voltage that is a voltage across the smoothing capacitor; a rotational speed comparison step of causing the one or more processors to compare a rotational speed of the power generator with a rotational speed threshold that has been predetermined; a voltage comparison step of causing the one or more processors to compare the capacitor voltage with a voltage threshold that has been predetermined; and a voltage utilization ratio comparison step of causing the one or more processors to compare a voltage utilization ratio, which is defined as a ratio of a voltage applied to the power generator to the capacitor voltage, with a voltage utilization ratio threshold that has been predetermined, wherein, in the control step, the power running control is performed in a case where: it is determined in the rotational speed comparison step that the rotational speed of the power generator is less than the rotational speed threshold; it is determined in the voltage comparison step that the capacitor voltage is equal to or greater than the voltage threshold; and it is determined in the voltage utilization ratio comparison step that the voltage utilization ratio is equal to or less than the voltage utilization ratio threshold.

A fourth aspect of the present disclosure is a program for causing a computer to execute the control method according to the third aspect.

According to the present disclosure, discharge of the smoothing capacitor can be performed in a suitable manner.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic view of a moving object;

FIG. 2 is a schematic view of a power supply system;

FIG. 3 is a circuit diagram of a PCU;

FIG. 4 is a control block diagram of a control device;

FIG. 5 is a block diagram of a control unit;

FIG. 6A is a diagram illustrating a d-q coordinate system;

FIG. 6B is a diagram illustrating a d-q coordinate system;

FIG. 7 is a flowchart showing a stop process of a PCU; and

FIG. 8 is a time chart after a stop of the power generation device is instructed.

### DETAILED DESCRIPTION OF THE INVENTION

Electric moving objects (electric moving bodies) equipped with a power generation device has been developed. The power generation device includes, for example, a gas turbine engine, a power generator, and a power control unit (PCU). The output shaft of the gas turbine engine is connected to the rotor of the power generator. When the gas turbine engine operates, the power generator outputs alternating-current (AC) power. The PCU converts AC power output from the power generator into direct-current (DC) power and supplies the DC power to a load device or the like.

The PCU includes a smoothing capacitor for suppressing ripples. When the power generation device is used as a power source for a load device, the smoothing capacitor is charged. On the other hand, when operation of the power generation device is stopped, it is necessary to discharge the smoothing capacitor. For example, the smoothing capacitor can be discharged by supplying electric power from the smoothing capacitor to the power generator.

However, when the voltage of the smoothing capacitor becomes too low in a state where rotation of the power generator is not stopped, an overcurrent may occur in the PCU. The present disclosure enables a smoothing capacitor provided in a PCU to be discharged in a preferred manner.

### [1. Moving Object 100]

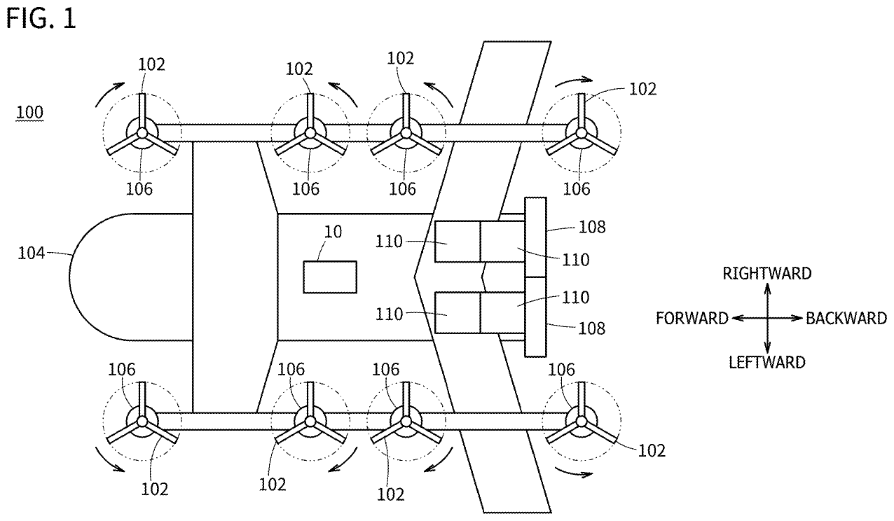

FIG. 1 is a schematic view of a moving object 100. The moving object 100 according to an embodiment is an electric vertical take-off and landing aircraft (eVTOL aircraft). The moving object 100 includes eight VTOL rotors 102. The VTOL rotor 102 generates thrust in the upward direction with respect to the airframe 104. The moving object 100 includes eight electric motors 106. One electric motor 106 drives one VTOL rotor 102. The moving object 100 includes two cruise rotors 108. The cruise rotor 108 generates thrust in the forward direction with respect to the airframe 104. The moving object 100 includes four electric motors 110. Two electric motors 110 drive one cruise rotor 108. The moving object 100 includes one or more power supply systems 10. The moving object 100 is not limited to an aircraft, and may be a ship, an automobile, a train, or the like.

### [2. Configuration of Power Supply System 10]

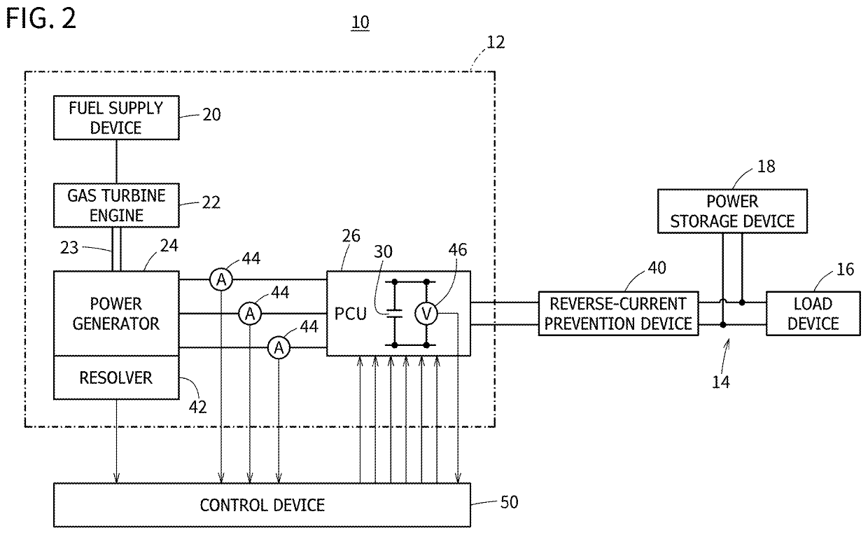

FIG. 2 is a schematic view of a power supply system 10. The power supply system 10 is provided in a moving object 100. In the power supply system 10, electric power can be supplied from a power generation device 12 to a load device 16 and a power storage device 18 via a power supply circuit 14. In the power supply system 10, electric power can be supplied from the power storage device 18 to the load device 16. In the power supply system 10, electric power may be supplied from the power storage device 18 to the power generation device 12 in accordance with an operation of the backflow prevention device (reverse-current prevention device) 40.

The power supply system 10 includes the power generation device 12. The power generation device 12 includes a fuel supply device 20, a gas turbine engine 22, a power generator 24, and a PCU (power conversion device) 26. The fuel supply device 20 includes a fuel tank, an electric pump, and a shutoff valve (none of which is shown). The electric pump supplies fuel sucked from the fuel tank to a combustor of the gas turbine engine 22. The gas turbine engine 22 includes a compressor, the combustor, and a turbine (none of which are shown). An output shaft 23 of the gas turbine engine 22 is connected to a rotor (not shown) of the power generator 24. The power generator 24 is a motor generator that can also function as an electric motor. The rotor of the power generator 24 rotates as the output shaft 23 of the gas turbine engine 22 rotates. Thus, the power generator 24 outputs, for example, three-phase AC power.

The PCU 26 may function as an AC-DC converter and an inverter. The AC terminals of the PCU 26 are connected to the output terminals of the power generator 24. The DC terminals of the PCU 26 are connected to the power supply circuit 14. The PCU 26 may convert three-phase AC power input from the AC terminals into DC power and output the DC power to the power supply circuit 14 connected to the DC terminals. The PCU 26 may convert DC power input from the DC terminals into three-phase AC power and output the three-phase AC power to the power generator 24 connected to the AC terminals. Further, the PCU 26 may convert electric power stored in a smoothing capacitor 30 into three-phase AC power and output the three-phase AC power to the power generator 24 connected to the AC terminals.

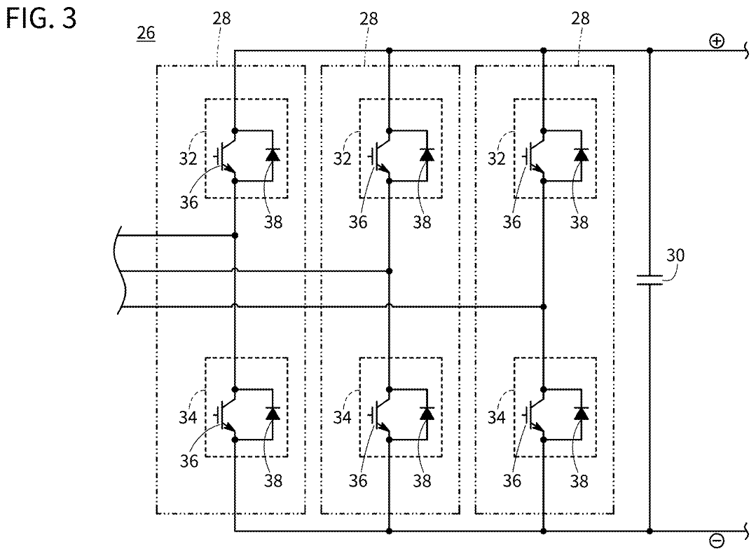

FIG. 3 is a circuit diagram of the PCU 26. The PCU 26 includes three power element units 28 corresponding to the three-phase voltages output from the power generator 24, and the smoothing capacitor 30. The three power element units 28 have the same configuration.

The power element unit 28 includes an upper arm 32 and a lower arm 34. Each of the upper arm 32 and the lower arm 34 includes a switching element 36 and a diode 38. In the power element unit 28, the switching element 36 of the upper arm 32 and the switching element 36 of the lower arm 34 are connected in series with each other. A first end of the switching element 36 of the upper arm 32 is connected to the positive wiring of the PCU 26. A second end of the switching element 36 of the upper arm 32 and a first end of the switching element 36 of the lower arm 34 are connected to one of the output terminals of the power generator 24. A second end of the switching element 36 of the lower arm 34 is connected to the negative wiring of the PCU 26. The anode of the diode 38 is connected to the second end of the switching element 36. The cathode of the diode 38 is connected to the first end of the switching element 36.

Referring back to FIG. 2, the description will be continued. The power supply system 10 includes the load device 16. The load device 16 includes one or more electric motors 106 and one or more electric motors 110 shown in FIG. 1. An inverter (not shown) is connected to each of the electric motors 106 and the electric motors 110. The inverter converts input DC power into three-phase AC power. The electric motors 106 and the electric motors 110 are driven by three-phase AC power. The load device 16 may include a DC-DC converter and a low-voltage drive device (none of which is shown).

The power supply system 10 includes the power storage device 18. The power storage device 18 is connected to the power supply circuit 14 in parallel with the PCU 26. The power storage device 18 includes a storage battery (for example, a lithium ion battery).

The power supply system 10 includes the backflow prevention device (reverse-current prevention device) 40. The backflow prevention device 40 is disposed in the power supply circuit 14. The backflow prevention device 40 limits supply of electric power from the power storage device 18 to the power generation device 12. The backflow prevention device 40 includes a diode (not shown). The backflow prevention device 40 includes a transistor that bypasses the diode (not shown). The transistor allows electric power to be supplied from the power storage device 18 to the power generation device 12, for example, by being supplied with an ON signal.

The power supply system 10 includes a resolver 42, three current sensors 44, and a voltage sensor 46. The resolver 42 detects a rotation angle of the output shaft 23 of the gas turbine engine 22 protruding from the power generator 24. Each current sensor 44 detects one of three phase currents flowing between the power generator 24 and the PCU 26. If two phase currents are known, the remaining phase current can be calculated. Therefore, the power supply system 10 may include two current sensors 44. The voltage sensor 46 detects voltage across the smoothing capacitor 30.

Hereinafter, the rotation angle of the output shaft 23 of the gas turbine engine 22 is also referred to as a rotation angle of the gas turbine engine 22. Similarly, the angular velocity of the output shaft 23 of the gas turbine engine 22 is also referred to as an angular velocity of the gas turbine engine 22. The rotational speed of the output shaft 23 of the gas turbine engine 22 is also referred to as a rotational speed of the gas turbine engine 22. The voltage across the smoothing capacitor 30 is also referred to as a capacitor voltage.

### [3. Control Device 50]

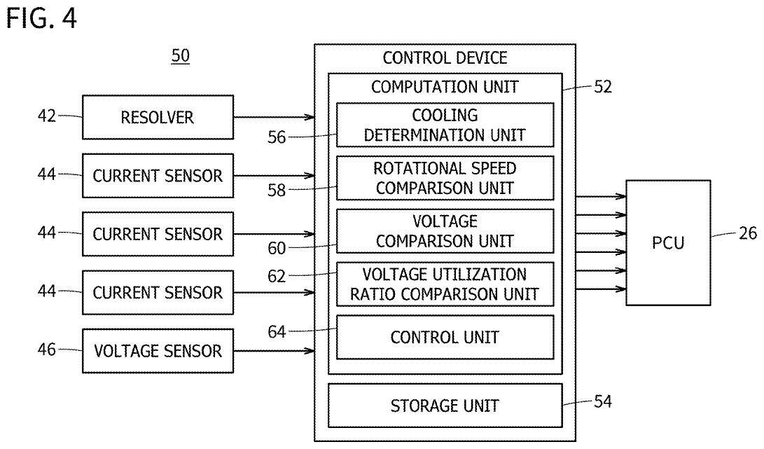

The power supply system 10 includes a control device 50. FIG. 4 is a control block diagram of the control device 50. The control device 50 is configured by, for example, an electronic control unit (ECU).

The control device 50 includes a computation unit 52 and a storage unit 54. The computation unit 52 is, for example, a processor such as a central processing unit (CPU), a graphics processing unit (GPU), or the like. The computation unit 52 includes a cooling determination unit 56, a rotational speed comparison unit 58, a voltage comparison unit 60, a voltage utilization ratio comparison unit 62, and a control unit 64. The cooling determination unit 56, the rotational speed comparison unit 58, the voltage comparison unit 60, the voltage utilization ratio comparison unit 62, and the control unit 64 are realized by the computation unit 52 executing a program stored in the storage unit 54. At least a part of the cooling determination unit 56, the rotational speed comparison unit 58, the voltage comparison unit 60, the voltage utilization ratio comparison unit 62, and the control unit 64 may be realized by an integrated circuit such as an application specific integrated circuit (ASIC) or a field-programmable gate array (FPGA). At least a part of the cooling determination unit 56, the rotational speed comparison unit 58, the voltage comparison unit 60, the voltage utilization ratio comparison unit 62, and the control unit 64 may be realized by an electronic circuit including a discrete device.

The storage unit 54 is a computer-readable non-transitory tangible storage medium. The storage unit 54 includes a volatile memory (not illustrated) and a non-volatile memory (not illustrated). The volatile memory is, for example, a random access memory (RAM). The non-volatile memory is, for example, a read only memory (ROM), a flash memory, or the like. Data and the like are stored in, for example, the volatile memory. Programs, tables, maps, and the like are stored, for example, in the non-volatile memory. At least a part of the storage unit 54 may be included in the processor, the integrated circuit, or the like as described above.

The cooling determination unit 56 determines whether or not cooling of the gas turbine engine 22 has been completed. This determination is referred to as a cooling determination. The cooling determination unit 56 may perform the cooling determination by acquiring information indicating the temperature of the gas turbine engine 22 from a sensor (not shown). The cooling determination unit 56 may perform the cooling determination by another method.

The rotational speed comparison unit 58 compares the rotational speed of the power generator 24 with a predetermined rotational speed threshold. The rotational speed comparison unit 58 determines whether the rotational speed of the power generator 24 is less than a rotational speed threshold. The rotational speed threshold is a boundary value used to determine whether to start discharge control of the smoothing capacitor 30. For example, the rotational speed threshold value is set to a rotational speed in a state where supply of fuel to the gas turbine engine 22 is stopped. The rotational speed threshold value can be set appropriately. The rotational speed threshold is stored in advance in the storage unit 54.

The voltage comparison unit 60 compares capacitor voltage with a predetermined voltage threshold. The voltage comparison unit 60 determines whether the capacitor voltage is equal to or higher than the voltage threshold. The voltage threshold is a boundary value used to determine whether discharge of the smoothing capacitor 30 is completed. The voltage threshold can be set appropriately. The voltage threshold is stored in advance in the storage unit 54.

The voltage utilization ratio comparison unit 62 compares the voltage utilization ratio with a predetermined voltage utilization ratio threshold. The voltage utilization ratio is a ratio of a voltage applied to the power generator 24 to the capacitor voltage. The voltage utilization ratio will be described in detail later. The voltage utilization ratio comparison unit 62 determines whether or not the voltage utilization ratio is equal to or less than the voltage utilization ratio threshold. The voltage utilization ratio threshold is a boundary value used to determine which of weak power running control and zero-torque control is to be performed. The voltage utilization ratio threshold is stored in advance in the storage unit 54.

The control unit 64 controls power supply to the DC terminals and power supply to the AC terminals by controlling on/off operations of the switching elements 36 provided in the PCU 26. The control unit 64 performs various types of power supply control. For example, the control unit 64 may perform discharge control to reduce the capacitor voltage. In the discharge control, the control unit 64 can perform weak power running control for controlling the PCU 26 such that electric power is supplied from the smoothing capacitor 30 to the power generator 24, and zero-torque control for controlling the PCU 26 such that the torque of the power generator 24 becomes zero.

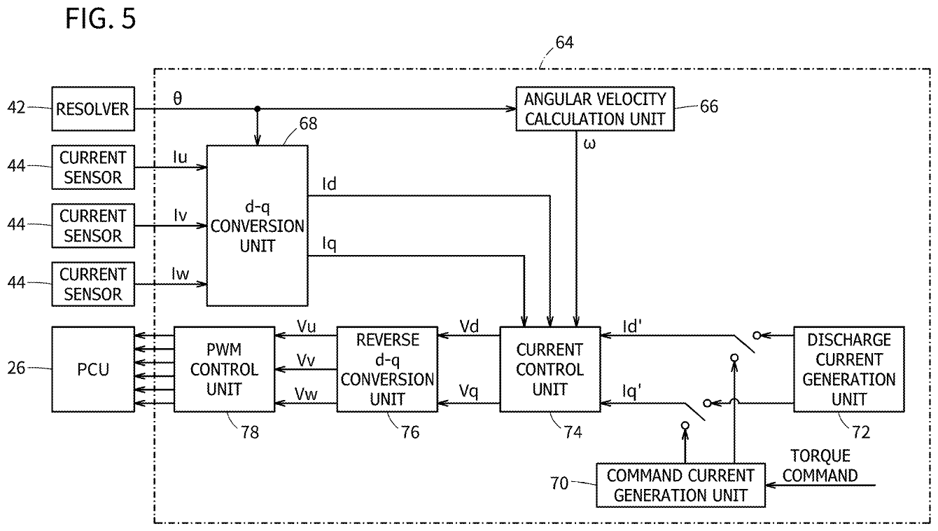

FIG. 5 is a block diagram of the control unit 64. The control unit 64 functions as an angular velocity calculation unit 66, a d-q conversion unit 68, a command current generation unit 70, a discharge current generation unit 72, a current control unit 74, a reverse d-q conversion unit 76, and a PWM control unit 78.

The angular velocity calculation unit 66 calculates the angular velocity (ω) of the gas turbine engine 22 based on the rotation angle (θ) detected by the resolver 42. The d-q conversion unit 68 calculates a d-axis current value (Id) and a q-axis current value (Iq) based on the rotation angle (θ) detected by the resolver 42 and the phase current values (Iu, Iv, Iw) detected by the current sensors 44.

The command current generation unit 70 and the discharge current generation unit 72 generate a d-axis current command value (Id′) and a q-axis current command value (Iq′), respectively. The command current generation unit 70 generates current command values (Id′, Iq′) of the respective axes based on torque command values acquired from a management ECU (not shown) that integrally manages a control system of the moving object 100, during normal control. On the other hand, the discharge current generation unit 72 generates the current command values (Id′, Iq′) of the respective axes, during discharge control for lowering the capacitor voltage of the smoothing capacitor 30. The command current generation unit 70 and the discharge current generation unit 72 are selectively used.

The current control unit 74 calculates a d-axis voltage command value (Vd) and a q-axis voltage command value (Vq), which are values of control voltages, based on the angular velocity (@) calculated by the angular velocity calculation unit 66, the current values (Id, Iq) of the respective axes calculated by the d-q conversion unit 68, and the current command values (Id′, Iq′) of the respective axes generated by the command current generation unit 70 or the discharge current generation unit 72. The reverse d-q conversion unit 76 calculates three-phase voltage command values (Vu, Vv, Vw), based on the rotation angle (θ) detected by the resolver 42 and the voltage command values (Vd, Vq) of the respective axes calculated by the current control unit 74. The PWM control unit 78 performs PWM (Pulse Width Modulation) control of the switching elements 36 provided in the PCU 26 based on the three-phase voltage command values (Vu, Vv, Vw) calculated by the reverse d-q conversion unit 76.

### [4. Discharge Control]

When the moving object 100 stops, a management ECU that integrally manages a control system of the moving object 100 causes each ECU included in the moving object 100 to execute stop control. During the stop control of the power generation device 12, supply of fuel to the gas turbine engine 22 is cut off. As a result, the rotational speed of the gas turbine engine 22 decreases.

The computation unit 52 performs discharge control to reduce the capacitor voltage of the smoothing capacitor 30 provided in the PCU 26, in a stop process of the PCU after an instruction to stop the power generation device 12. Specifically, the computation unit 52 performs the discharge control when the rotational speed of the gas turbine engine 22 decreases. The computation unit 52 performs either the weak power running control or the zero-torque control in the discharge control.

When the power generator 24 is driven by electric power stored in the smoothing capacitor 30 (power-running), the capacitor voltage decreases. However, if the capacitor voltage becomes excessively low before the rotational speed of the gas turbine engine 22 sufficiently decreases, the power generator 24 may resume power generation, which can result in an overcurrent flowing to the PCU 26. In order to reduce the capacitor voltage while preventing the overcurrent from flowing to the PCU 26, it is necessary to gradually discharge the smoothing capacitor 30. In the present embodiment, the voltage utilization ratio comparison unit 62 monitors the voltage utilization ratio, and the control unit 64 performs the discharge control based on the result.

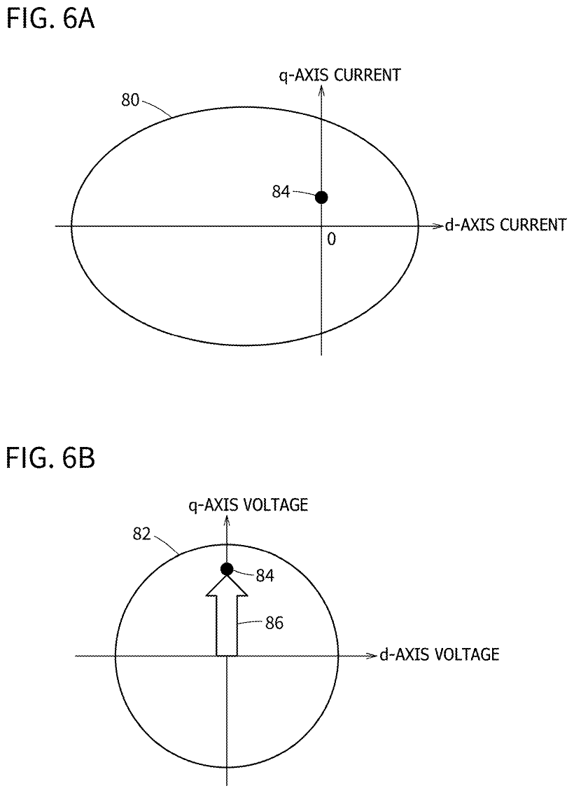

Hereinafter, the reason why the voltage utilization ratio is used in the present embodiment will be described. FIGS. 6A and 6B are diagrams illustrating a d-q coordinate system. FIG. 6A shows a voltage limit ellipse 80 in a d-q axis current coordinate system. FIG. 6B shows a voltage limit circle 82 in a d-q axis voltage coordinate system. The voltage limit circle 82 shown in FIG. 6B corresponds to the voltage limit ellipse 80 shown in FIG. 6A. The voltage limit ellipse 80 indicates a controllable range of the DC voltage in the motor control. The voltage limit circle 82 indicates an allowable range of a voltage command vector 86 in the motor control. The DC voltage represents the maximum voltage that can be supplied to the motor. The DC voltage mentioned here corresponds to the capacitor voltage of the smoothing capacitor 30 of the present embodiment. The motor corresponds to a motor generator of the present embodiment, that is, the power generator 24.

In general, the voltage limit ellipse 80 and the voltage limit circle 82 are determined by the DC voltage and the rotational speed of the motor shaft. When the DC voltage decreases or the rotational speed of the motor shaft increases, the voltage limit ellipse 80 becomes smaller. That is, the controllable range of the motor becomes smaller. On the other hand, when the DC voltage increases or the rotational speed of the motor shaft decreases, the voltage limit ellipse 80 becomes larger. That is, the controllable range of the motor becomes larger. On the other hand, the range of the voltage limit circle 82 depends on the DC voltage. The control point 84 of the motor shifts toward the positive side of the q-axis as the rotational speed of the motor increases. The shift amount of the control point 84 of the motor decreases as the rotational speed of the motor decreases. In order to control the motor, it is necessary to keep the control point 84 of the motor within the voltage limit ellipse 80 and within the voltage limit circle 82. As the rotational speed of the motor increases, the q-axis voltage component necessary for control increases. Accordingly, the controllable range of the motor is substantially reduced. When the control point 84 falls outside the voltage limit ellipse 80 and outside the voltage limit circle 82, it becomes difficult to control the motor.

In FIG. 6B, the control point 84 is indicated by a d-axis voltage command value (Vd) and a q-axis voltage command value (Vq). The sum of the vector of the d-axis voltage command value and the vector of the q-axis voltage command value corresponds to the voltage command vector 86. The voltage utilization ratio is the ratio of the voltage command vector 86 to the DC voltage. The voltage utilization ratio is calculated by the following equation (1).

$$Voltage Utilization Ratio = \frac{Vdqamp}{VDC / \sqrt{2}} \qquad ( 1 )$$

$$Vdqamp = \sqrt{{Vd}^{2} + {Vq}^{2}} \qquad ( 2 )$$

$$Vd = rId - ω LqIq \qquad ( 3 )$$

$$Vq = ω LdId + rIq + ω ψ a \qquad ( 4 )$$

The variables contained in the above Equations (1) to (4) are as follows.
VDC: capacitor voltage
Vd: d-axis voltage command value
Vq: q-axis voltage command value
r: winding resistance
Id: d-axis current
Iq: q-axis current
ω: angular velocity of the power generator 24
Ld: d-axis inductance
Lq: q-axis inductance
ψa: interlinkage magnetic flux

In the present embodiment, the voltage utilization ratio threshold is set to keep the control point 84 within the voltage limit ellipse 80 and the voltage limit circle 82. The voltage utilization ratio threshold is less than or equal to 1. When the voltage utilization ratio is equal to or less than the voltage utilization ratio threshold, the control point 84 falls within the voltage limit ellipse 80 and within the voltage limit circle 82. This enables the control unit 64 to perform control to cause the power generator 24 to perform power-running (i.e., operate in a motoring mode) at the control point 84. This control is referred to as a weak power running control. The weak power running control is control that gradually lowers the capacitor voltage by gradually discharging the smoothing capacitor 30.

As described above, the voltage limit ellipse 80 and the voltage limit circle 82 are determined by the DC voltage (capacitor voltage) and the rotational speed of the motor shaft (the rotational speed of the power generator 24). As the weak power running control is executed, the control point 84 may shift outside the voltage limit ellipse 80 and the voltage limit circle 82. In this case, the voltage utilization ratio exceeds the voltage utilization ratio threshold. When the voltage utilization ratio exceeds the voltage utilization ratio threshold, the control unit 64 temporarily stops the weak power running control and performs zero-torque control to flow only the d-axis current. Accordingly, the control point 84 returns to inside of the voltage limit ellipse 80 and inside of the voltage limit circle 82. As a result, the voltage utilization ratio becomes equal to or less than the voltage utilization ratio threshold.

### [5. Operation]

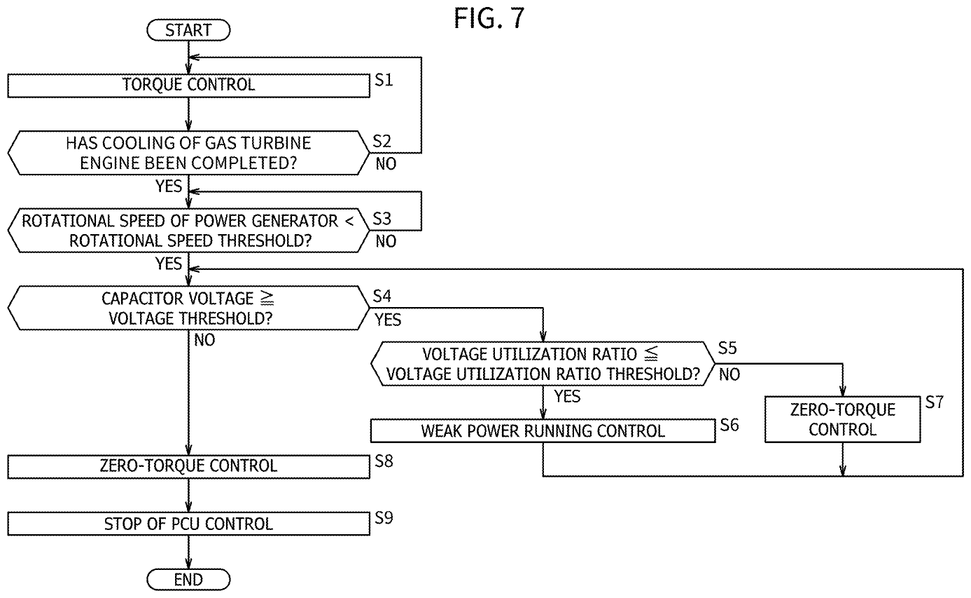

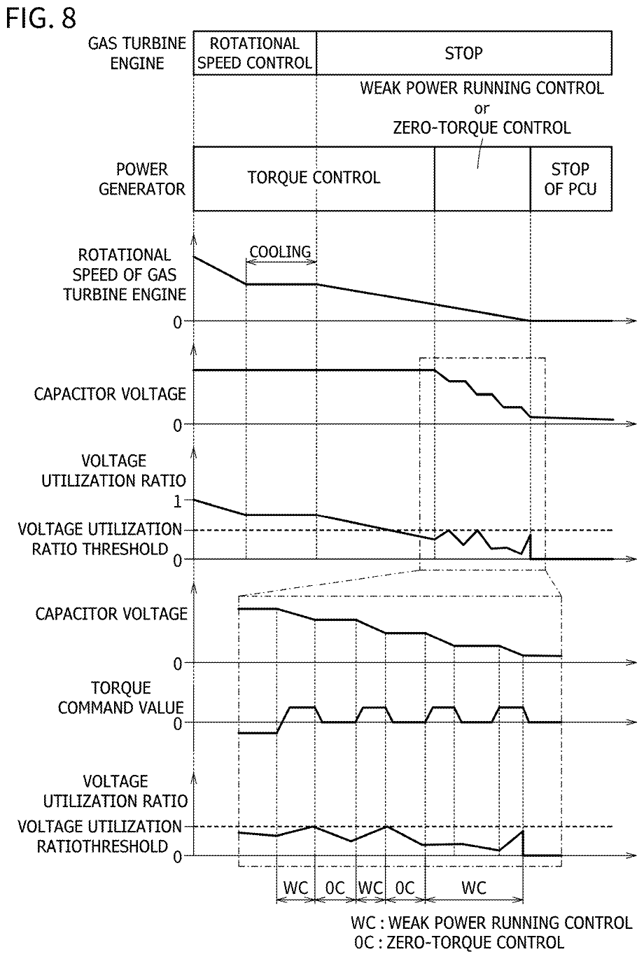

FIG. 7 is a flowchart showing a stop process of a PCU; and FIG. 8 is a time chart after a stop of the power generation device 12 is instructed. When the moving object 100 is stopped, the management ECU included in the moving object 100 instructs an engine ECU (not shown) that controls the fuel supply device 20 and the control device 50 that controls the PCU 26 to stop the power generation device 12. The engine ECU performs a stop process of the gas turbine engine 22 in response to the stop instruction. On the other hand, the control device 50 performs a stop process of the PCU 26 shown in FIG. 7 in response to the stop instruction. Note that, of step S1 to step S9 in FIG. 7, step S4 to step S7 correspond to the discharge control.

In step S1, the control unit 64 performs normal torque control. In step S2, the cooling determination unit 56 determines whether cooling of the gas turbine engine 22 has been completed. When the cooling of the gas turbine engine 22 is completed (step S2: YES), the process proceeds to step S3. In this case, supply of fuel to the gas turbine engine 22 is cut off. On the other hand, when the cooling of the gas turbine engine 22 is not completed (step S2: NO), the process returns to step S1.

When the cooling of the gas turbine engine 22 is completed, the engine ECU cuts off supply of fuel to the gas turbine engine 22. As a result, the rotational speed of the gas turbine engine 22 and the rotational speed of the power generator 24 gradually decrease.

When the process transitions from step S2 to step S3, the rotational speed comparison unit 58 compares the rotational speed of the power generator 24 with the rotational speed threshold. The rotational speed comparison unit 58 determines whether or not the rotational speed of the power generator 24 has decreased to a rotational speed at which the discharge control can be executed. When the rotational speed of the power generator 24 is less than the rotational speed threshold (step S3: YES), the process proceeds to step S4. On the other hand, when the rotational speed of the power generator 24 is equal to or higher than the rotational speed threshold (step S3: NO), the determination of step S3 is repeatedly executed.

When the process transitions from step S3 to step S4, the voltage comparison unit 60 compares the capacitor voltage of the smoothing capacitor 30 with the voltage threshold. When the capacitor voltage is equal to or higher than the voltage threshold (step S4: YES), the process proceeds to step S5. On the other hand, when the capacitor voltage is less than the voltage threshold (step S4: NO), the process proceeds to step S8.

When the process transitions from step S4 to step S5, the voltage utilization ratio comparison unit 62 compares the voltage utilization ratio with the voltage utilization ratio threshold. Here, the voltage utilization ratio comparison unit 62 calculates the voltage utilization ratio using the above Equations (1) to (4). The voltage utilization ratio comparison unit 62 uses the most recent voltage command value of each axis as the d-axis voltage command value (Vd) and the q-axis voltage command value (Vq) in the above Equation (2). When the voltage utilization ratio is equal to or less than the voltage utilization ratio threshold (step S5: YES), the process proceeds to step S6. On the other hand, when the voltage utilization ratio is larger than the voltage utilization ratio threshold (step S5: NO), the process proceeds to step S7.

When the process transitions from step S5 to step S6, the control unit 64 performs the weak power running control of the power generator 24. As shown in FIG. 8, the control unit 64 continuously performs the weak power running control, so that the capacitor voltage of the smoothing capacitor 30 gradually decreases.

When the process transitions from step S5 to step S7, the control unit 64 performs zero-torque control of the power generator 24. As shown in FIG. 8, the voltage utilization ratio decreases as the control unit 64 continues to perform the zero-torque control. The capacitor voltage of the smoothing capacitor 30 decreases as a result of the zero-torque control being performed. However, the rate of decrease in the capacitor voltage resulting from the zero-torque control is smaller than the rate of decrease in the capacitor voltage resulting from the weak power running control.

At the stage of transition from step S4 to step S8, the discharge of the smoothing capacitor 30 is substantially completed. In this state, the control unit 64 performs the zero-torque control of the power generator 24 for a predetermined time. Accordingly, when the power supply system 10 needs to be restarted within a short time after the gas turbine engine 22 has been stopped, the power supply system 10 can be restarted quickly.

In step S9, the control unit 64 turns off the gates of the switching elements of the PCU 26 and stops control of the PCU 26.

The stop process of the PCU shown in FIG. 7 may be modified in various ways. For example, the process of step S8 may be omitted.

In the present embodiment, the voltage utilization ratio comparison unit 62 monitors the voltage utilization ratio and determines whether or not the voltage utilization ratio is equal to or less than the voltage utilization ratio threshold. That is, the voltage utilization ratio comparison unit 62 determines whether or not the control point 84 of the power generator 24 falls within the voltage limit ellipse 80 and within the voltage limit circle 82. The control unit 64 performs the power running control to promote discharge of the smoothing capacitor 30, in a state where the control point 84 of the power generator 24 falls within the voltage limit ellipse 80 and within the voltage limit circle 82. Thus, the discharge of the smoothing capacitor 30 can be performed in accordance with the degree of decrease in the rotational speed of the power generator 24, and therefore, it is possible to prevent an overcurrent from flowing to the PCU 26 due to power generation of the power generator 24.

According to the present embodiment, it is possible to reduce the capacitor voltage of the smoothing capacitor 30 while reducing the rotational speed of the gas turbine engine 22. That is, the stop process of the gas turbine engine 22 and the discharge of the smoothing capacitor 30 can be performed at the same time. Therefore, the stop process of the power generation device 12 can be efficiently performed.

### [6. Supplementary Notes]

The following Supplementary Notes are further disclosed in relation to the above embodiments.

### Supplementary Note 1

The control device (50) of the present disclosure is the control device provided in the power supply system (10) including the power conversion device (26) that converts alternating-current power output from the power generator (24) into direct-current power, the control device including: the control unit (64) configured to perform power running control to control the power conversion device in a manner so that electric power is supplied from the smoothing capacitor (30) provided in the power conversion device to the power generator, thereby reducing the capacitor voltage that is a voltage across the smoothing capacitor; the rotational speed comparison unit (58) configured to compare the rotational speed of the power generator with the rotational speed threshold that has been predetermined; the voltage comparison unit (60) configured to compare the capacitor voltage with the voltage threshold that has been predetermined; and the voltage utilization ratio comparison unit (62) configured to compare the voltage utilization ratio, which is defined as a ratio of the voltage applied to the power generator to the capacitor voltage, with the voltage utilization ratio threshold that has been predetermined, wherein the control unit performs power running control in a case where: the rotational speed comparison unit determines that the rotational speed of the power generator is less than the rotational speed threshold; the voltage comparison unit determines that the capacitor voltage is equal to or greater than the voltage threshold; and the voltage utilization ratio comparison unit determines that the voltage utilization ratio is equal to or less than the voltage utilization ratio threshold.

According to the above configuration, the discharge of the smoothing capacitor can be performed in accordance with the degree of decrease in the rotational speed of the power generator, and therefore, it is possible to prevent an overcurrent from flowing to the power conversion device due to power generation of the power generator.

### Supplementary Note 2

In the control device according to Supplementary Note 1, when the voltage comparison unit determines that the capacitor voltage is less than the voltage threshold, the control unit may perform zero-torque control that is control for making the torque of the power generator zero.

### Supplementary Note 3

In the control device according to Supplementary Note 1, when the voltage utilization ratio comparison unit determines that the voltage utilization ratio is larger than the voltage utilization ratio threshold, the control unit may perform zero-torque control that is control for making the torque of the power generator zero.

### Supplementary Note 4

In the control device according to Supplementary Note 1, the control unit may perform the power running control when the power generator is stopped.

### Supplementary Note 5

The moving object (100) of the present disclosure includes the power supply system including the control device according to any one of Supplementary Notes 1 to 4.

### Supplementary Note 6

The control method of the present disclosure is the control method for the power supply system including the power conversion device that converts alternating-current power output from the power generator into direct-current power, the control method including: the control step (step S6) of causing one or more processors to perform power running control for controlling the power conversion device in a manner so that electric power is supplied from the smoothing capacitor included in the power conversion device to the power generator, thereby reducing the capacitor voltage that is a voltage across the smoothing capacitor; the rotational speed comparison step (step S3) of causing the one or more processors to compare the rotational speed of the power generator with the rotational speed threshold that has been predetermined; the voltage comparison step (step S4) of causing the one or more processors to compare the capacitor voltage with the voltage threshold that has been predetermined; and the voltage utilization ratio comparison step (step S5) of causing the one or more processors to compare the voltage utilization ratio, which is defined as a ratio of a voltage applied to the power generator to the capacitor voltage, with the voltage utilization ratio threshold that has been predetermined, wherein, in the control step, the power running control is performed in a case where: it is determined in the rotational speed comparison step that the rotational speed of the power generator is less than the rotational speed threshold; it is determined in the voltage comparison step that the capacitor voltage is equal to or greater than the voltage threshold; and it is determined in the voltage utilization ratio comparison step that the voltage utilization ratio is equal to or less than the voltage utilization ratio threshold.

### Supplementary Note 7

The program according to the present disclosure causes a computer to execute the control method according to Supplementary Note 6.

Although the present disclosure has been described in detail, the present disclosure is not limited to the above-described embodiments. In these embodiments, various addition, replacement, changing, partial deletions, and the like can be made without departing from the essence and gist of the present disclosure or without departing from the essence and gist of the present disclosure derived from the contents described in the claims and equivalents thereof. These embodiments may also be implemented in combination. For example, in the above-described embodiments, the order of operations and the order of processes are shown as examples, and the present invention is not limited to them. The same applies to a case where numerical values or mathematical equations are used in the description of the above-described embodiments.

1. A control device provided in a power supply system including a power conversion device that converts alternating-current power output from a power generator into direct-current power, the control device comprising:
one or more processors that execute computer-executable instructions stored in a memory,
wherein the one or more processors execute the computer-executable instructions to cause the control device to:
perform power running control to control the power conversion device in a manner so that electric power is supplied from a smoothing capacitor provided in the power conversion device to the power generator, to thereby reduce a capacitor voltage that is a voltage across the smoothing capacitor;
compare a rotational speed of the power generator with a rotational speed threshold that has been predetermined;
compare the capacitor voltage with a voltage threshold that has been predetermined; and
compare a voltage utilization ratio, which is defined as a ratio of a voltage applied to the power generator to the capacitor voltage, with a voltage utilization ratio threshold that has been predetermined, and
wherein the one or more processors cause the control device to perform the power running control in a case where: it is determined that the rotational speed of the power generator is less than the rotational speed threshold; it is determined that the capacitor voltage is equal to or greater than the voltage threshold; and it is determined that the voltage utilization ratio is equal to or less than the voltage utilization ratio threshold.

2. The control device according to claim 1, wherein
the one or more processors execute the computer-executable instructions to cause the control device to:
perform zero-torque control that is control for making a torque of the power generator zero, in a case where it is determined that the capacitor voltage is less than the voltage threshold.

3. The control device according to claim 1, wherein
the one or more processors execute the computer-executable instructions to cause the control device to:
perform zero-torque control that is control for making a torque of the power generator zero, in a case where it is determined that the voltage utilization ratio is larger than the voltage utilization ratio threshold.

4. The control device according to claim 1, wherein
the one or more processors execute the computer-executable instructions to cause the control device to:
perform the power running control when the power generator is stopped.

5. A moving object comprising a power supply system including the control device according to claim 1.

6. A control method for a power supply system including a power conversion device that converts alternating-current power output from a power generator into direct-current power, the control method comprising:
causing one or more processors to perform power running control to control the power conversion device in a manner so that electric power is supplied from a smoothing capacitor included in the power conversion device to the power generator, to thereby reduce a capacitor voltage that is a voltage across the smoothing capacitor;
causing the one or more processors to compare a rotational speed of the power generator with a rotational speed threshold that has been predetermined;
causing the one or more processors to compare the capacitor voltage with a voltage threshold that has been predetermined; and
causing the one or more processors to compare a voltage utilization ratio, which is defined as a ratio of a voltage applied to the power generator to the capacitor voltage, with a voltage utilization ratio threshold that has been predetermined,
wherein
the one or more processors perform the power running control in a case where: it is determined in the comparing regarding the rotational speed that the rotational speed of the power generator is less than the rotational speed threshold; it is determined in the comparing regarding the capacitor voltage that the capacitor voltage is equal to or greater than the voltage threshold; and it is determined in the comparing regarding the voltage utilization ratio that the voltage utilization ratio is equal to or less than the voltage utilization ratio threshold.

7. A non-transitory computer-readable storage medium storing a program for causing a computer to execute the control method according to claim 6.
